(19) United States
(12) Patent Application Publication
(10) Pub. No.: US 2013/0339039 A1
(43) Pub. Date: Dec. 19, 2013

(54) Mobile Wireless Medical Practitioner, Patient, and Medical Object Recognition and Control

(71) Applicants: Kendyl A. Román, Sunnyvalle, CA (US); John Livacich, Sunnyvalle, CA (US)

(72) Inventors: Kendyl A. Román, Sunnyvalle, CA (US); John Livacich, Sunnyvalle, CA (US)

(21) Appl. No.: 13/525,275

(22) Filed: Jun. 16, 2012

(51) Int. Cl. G06Q 50/22

(52) U.S. Cl. 705/2

(57) ABSTRACT

A system, handheld devices, and methods for medical object tracking and control. The system tracks and controls items, medical practitioners, patients, and their interactions. The handheld mobile wireless device provides item specific information, instruction, and supervision. A plurality of handheld devices is configured to be used by different medical practitioners, and communicate with a central database. A handheld device comprises a camera for scanning an image of a medical object, a display for displaying information, and a wireless network connection to the database. The system recognizes the medical object and identifies a person, either as a medical practitioner, medical technician, or patient. The database includes information regarding people and their roles, permissions, and authorized or assigned tasks; medical objects and tools; medical object specific instructions; and the handheld devices. An observer, or the system, can monitor the performance of the tasks, and provide corrective feedback.

### BACKGROUND

1. Field of Invention

The present invention relates to object recognition and control, in particular the invention relates to medical object recognition and control including mobile wireless devices for use with medical practitioners.

2. Description of Prior Art

Various attempts have been made to create a patient medical record system and to track medications and material used with various patients in hospitals and in other health care environments. However these systems are hard to use, require time-consuming data entry, require time-consuming data lookup and navigation, and fail to eliminate errors in the administration of medication and the performance of medical procedures.

Various attempts have been made to label objects with labels that can be read automatically by a computing machine. Barcodes have proven to be an effective scheme for achieving these purposes. Originally, linear or one-dimensional barcodes such as the Universal Product Code (UPC) were used. The UPC was the first commercially successful model and enjoyed widespread universal use.

Later a two-dimensional or matrix code was developed. These are similar to one-dimensional codes, but represent more data per unit area and traditionally utilize square pixels. While the UPC represents a serial number, matrix codes can represent text, URLs, or other data. The Quick Response Code (QR Code or QRC) is one of the most popular types of two-dimensional codes and is often used with smart phones.

More recently, a third-generation barcode called the High Capacity Color Barcode (HCCB) was developed. This two-dimensional barcode uses multi-colored triangles for an increase in data density, but still represents the same types of data.

Bar code readers are typically connected to computer systems and databases to keep track of sales or inventory.

These conventional methods have many drawbacks and limitations including the inability to identify individuals in various disciplines and roles and correlate relationships, tasks, permissions, etc. with other objects and/or individuals. In addition, these methods lack the ability to provide and present training, instructional and other information in various forms for maintenance and other purposes.

There is a need for mobile wireless handheld devices to be able to recognize various objects and people and to provide for training, instruction, tracking, monitoring, and observation, which are authorized, and object specific. Further there is a need to be able to confirm that maintenance or use procedures are performed properly while they are being performed.

### SUMMARY OF THE INVENTION

It is an objective of the present invention to provide a means and method of identifying objects that include and go beyond those currently identifiable by conventional labels and go beyond existing tracking systems. Although traditional coded labels have proven to be an effective scheme for achieving item identification, they by themselves fall short of being able to achieve a more universal means and method of medical object recognition, training, instruction, tracking, monitoring, observation, and control. Handheld mobile wireless devices are used with medical objects and individuals to provide up-to-date pertinent information using methods such as on screen instructions, checklists, videos, pictures, diagrams, etc. or any combination thereof. Items and people are identified by scanning a label attached to the item or medical practitioner/technician, or by use of object recognition, facial recognition, or other biological recognition, such as iris scan, fingerprint scan, or other recognition known in the art. The system tracks and controls items, people, and their interactions. The handheld mobile wireless device provides item specific information, instruction, and supervision.

A system aspect of the invention comprises a plurality of handheld devices used by different people, and a database in communication with the handheld devices.

A handheld device comprises a camera for scanning an image of a medical object, a display for displaying information, and a wireless network connection to the database for sending and receiving data.

The system recognizes the medical object by interpreting the image. In some embodiments, a coded label, e.g. a UPC or QR code, is interpreted. The system also identifies a medical practitioner/technician. The medical practitioner/technician may be identified by being associated with the handheld device; by scanning a scan label, such as an ID badge, ID card, or tattoo; or by scanning a face, a fingerprint, an iris, or other biometric.

The database includes information regarding people and their roles, permissions, and authorized or assigned tasks; medical objects and tools; medical object specific instructions; and the handheld devices. The database also records information regarding the interaction between the medical objects and the people.

The roles include maintenance, use, and observation, and may vary based on the medical object.

The medical object specific instructions include documents, checklists, pictures, audio, and video.

When the handheld device scans a medical object, the medical object is recognized, the medical practitioner/technician and their role are identified, and if the medical practitioner/technician is authorized the handheld device provides medical object specific instructions.

In some situations, an observer is notified when use, or maintenance, is started by another medical practitioner/technician who is a user, or a maintainer, respectively.

An observer, or in some embodiments, the automated system, can monitor the proper performance of the tasks, and provide corrective feedback during the performance.

Method aspects of the invention include capturing an image with the camera of the handheld device, interpreting the image, determining a medical object, determining a medical practitioner/technician, and if the medical practitioner/technician is authorized determining a role of the medical practitioner/technician.

A method of performing maintenance includes identifying a current part and any associated tools, providing medical object specific instructions for the current maintenance task, confirm completion of the task, and recording completion of the task, and repeating for each maintenance task.

A method of performing use includes identifying tools, if any, providing medical object specific instructions for the current use task, confirm completion of the use, and recording information regarding the use, and repeating for each use task.

A method of performing observation includes providing medical object specific instructions if required, and recording information regarding the start and finish of the observation, and repeating for each observation task.

### OBJECTS AND ADVANTAGES

Accordingly, the present invention includes the following advantages:
1. To provide a means and method of medical object recognition and control.
2. To provide a means and method of recognition and control of medical practitioners and patients.
3. To provide a means and method of medical object recognition and control that is role based.
4. To provide a means and method of medical object recognition and control that is discipline based.
5. To provide a means and method of medical object recognition and control that is used for verification and ratification.
6. To provide a means and method of medical object recognition and control that is used for maintenance notification, instructions, and tracking.
7. To provide a means and method of medical object recognition and control that is used to log maintenance and events.
8. To provide a means and method of medical object recognition and control that is used for reporting.
9. To provide a means and method of medical object recognition and control that is used for presenting information in a variety of mediums including documents, pictures, diagrams, video, audio, etc.
10. To provide a means and method of medical object recognition and control that is used for problem solving via knowledge bases that are associated with medical objects and individuals.
11. To provide a means and method of medical object recognition and control that is easy to use.
12. To provide a means and method of medical object recognition and control that is quick and effective.
13. To provide a means and method of medical object recognition and control that is cost effective.
14. To provide a means and method of medical object recognition and control that simplifies medical procedures.
15. To provide a means and method of medical object recognition and control that allows easier access to patient information.
16. To provide a means and method of medical object recognition and control for a medical practitioner to efficiently and quickly identify and treat patients.
17. To provide a means and method of medical object recognition and control for a medical practitioner to accurately treat patients.

### DRAWING FIGURES

In the drawings, closely related figures have the same number but different alphabetic suffixes.

FIG. 1A through FIG. 1C show prior art coded labels, such as bar codes and QR codes.

FIG. 2 illustrates the system with people with different roles and separate handheld devices communicating with the same database and server.

FIG. 3A through FIG. 3D illustrate flowcharts of showing the exemplary steps for the methods of the system.

FIG. 4 illustrates the structure of the database.

FIG. 5 illustrates a medical practitioner with a mobile device with patients and medical devices and cameras for remote observation.

REFERENCE NUMERALS IN DRAWINGS

| | | |
|---|---|---|
| 100 | a-d | coded label |
| 101 | | universal product code (UPC) |
| 102 | | quick response (QR) code |
| 103 | | high capacity color barcode (HCCB) |
| 120 | a-c | scan label |
| 200 | a-c | medical object |
| 210 | a-c | handheld device |
| 211 | a-c | image data |
| 212 | a-c | outgoing database information |
| 213 | a-c | incoming database information |
| 220 | | maintainer |
| 230 | | user |
| 240 | | observer |
| 250 | | database |
| 300 | | start |
| 301 | | path |
| 302 | | capture image |
| 303 | | path |
| 304 | | interpret image |
| 305 | | path |
| 306 | | determine object |
| 307 | | path |
| 308 | | determine person |
| 309 | | path |
| 310 | | is person authorized |
| 311 | | path |
| 312 | | determine role |
| 313 | | path |
| 314 | | no access |
| 315 | | path |
| 316 | | maintenance? |
| 317 | | path |
| 318 | | perform maintenance |
| 319 | | path |
| 320 | | use? |
| 321 | | path |
| 322 | | perform use |
| 323 | | path |
| 324 | | observe? |
| 325 | | path |
| 326 | | perform observation |
| 327 | | path |
| 329 | | path |
| 331 | | path |
| 332 | | identify part |
| 333 | | path |
| 334 | | identify tools |
| 335 | | path |
| 336 | | provide instruction |
| 337 | | path |
| 338 | | notify observer of start |
| 339 | | path |
| 340 | | confirm completion |
| 341 | | path |
| 342 | | record completion |
| 343 | | path |
| 344 | | notify observer of completion |
| 345 | | path |
| 346 | | more tasks? |
| 347 | | path |
| 348 | | exit |
| 349 | | path |
| 350 | | path |
| 351 | | path |
| 352 | | tools required? |
| 353 | | path |
| 354 | | identify tools |
| 355 | | path |
| 356 | | provide instruction |
| 357 | | path |
| 358 | | notify observer of start |
| 359 | | path |
| 360 | | confirm use |
| 361 | | path |
| 362 | | record use |
| 363 | | path |
| 364 | | notify observer of completion |
| 365 | | path |
| 366 | | more tasks? |
| 367 | | path |
| 368 | | exit |
| 369 | | path |
| 370 | | path |
| 371 | | path |
| 372 | | instruction needed? |
| 373 | | path |
| 374 | | provide instruction |
| 375 | | path |
| 376 | | record observation start |
| 377 | | path |
| 378 | | communicate with others |
| 379 | | path |
| 380 | | record observation finish |
| 381 | | path |
| 382 | | more tasks? |
| 383 | | path |
| 384 | | exit |
| 385 | | path |
| 400 | | roles |
| 402 | | people |
| 404 | | objects (tools) |
| 406 | | tasks |
| 408 | | task list |
| 410 | | devices |
| 500 | | patient |
| 510 | | tool |
| 520 | | mounted camera |
| 550 | | mounting structure |

### DESCRIPTION OF THE INVENTION

### Prior Art Coded Labels

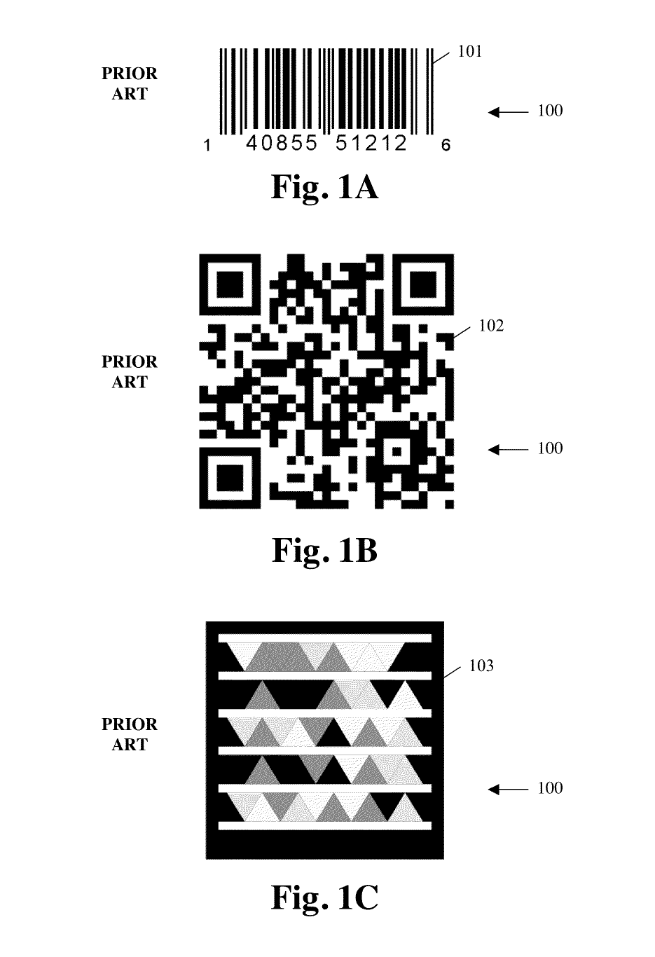

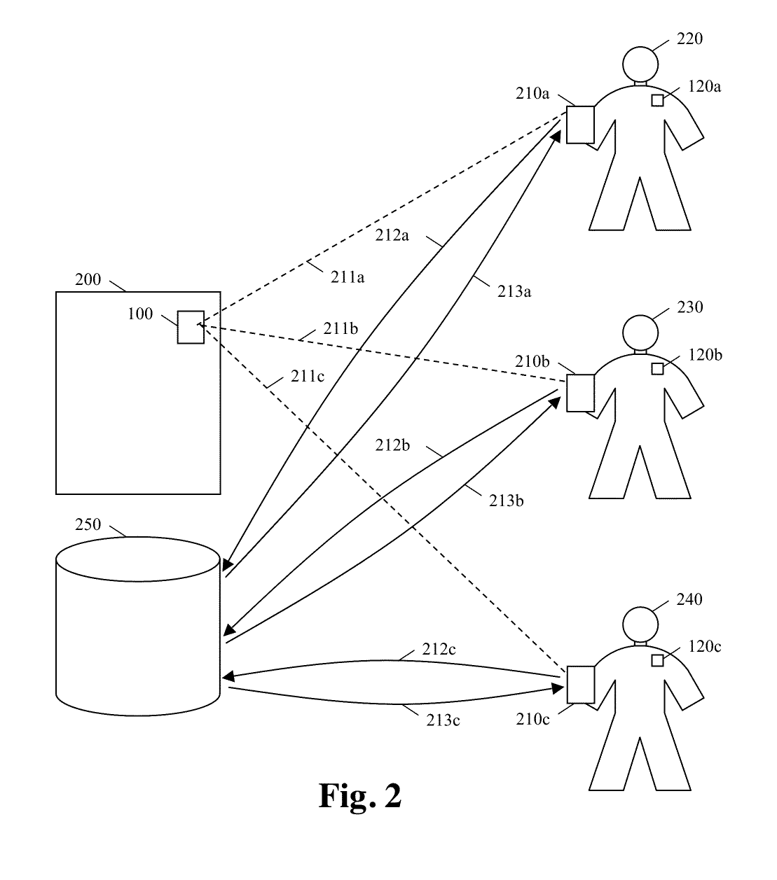

FIG. 1A through FIG. 1C show prior art coded labels 100.

FIG. 1A illustrates an example of a coded label 100 with a barcode, in particular universal product code (UPC) 101. A barcode or UPC typically represents a number. The UPC system allows each product to have a unique code making the system universal. However, individual products can only be identified with an additional label such a serial number barcode.

FIG. 1B illustrates an example of a coded label 100 with a quick response (QR) code 102. A QR code 102 has high data density. It can encode free form text and is typically used to encode a direct address of other information such as an URL.

FIG. 1C illustrates an example of a coded label 100 with a high capacity color barcode (HCCB) 103. A HCCB may also contain a direct address such as an URL.

### Handheld Devices Used for Medical Object Recognition and Control and Instruction

FIG. 2 illustrates a system with people with different roles and separate handheld devices communicating with the same database and server. Each medical practitioner/technician is shown with a handheld device 210. The handheld device 210 is preferably a mobile wireless device. The handheld device 210 includes a camera, which can scan an image of a medical object 200. A coded label 100 on medical object 200 is initially scanned as image data 211a-c by any of the handheld devices 210a-c, which is operated by a maintainer 220, a user 230, and/or an observer 240, respectively. The observer 240 can be a manager, supervisor, or team leader, etc. The handheld devices 210a-c each interacts with the same database 250 to send and receive information. Information sent to the database 250 is outgoing database information 212a-c respectively. For example, when maintainer 220 scans the coded label 100 on medical object 200, the image data 211a is interpreted by the handheld device 210a and the decoded data is sent to the database 250 as outgoing database information 212a. The maintainer 220 may also be recognized, for example, by scanning scan label 120a. Information sent from the database 250 to the handheld devices 210a-c is incoming database information 213a-c, respectively. Incoming database information 213 may be directed to the maintainer 220, the user 230, and/or the observer 240. The information in database 250 can include instructions, tools list and maintenance logs. The data in the database 250 may describe each person's role, authorization, security access or other information. For example, after receiving the decoded data from the handheld device 210a, incoming database information 213a sent to the maintainer 220 would include instructions and a list of tasks, which may be customized to the specific maintainer 220 (as identified e.g. by scan label 120a). The maintainer 220 may receive information about the parts on or in the identified medical object 200. The maintainer 220 may also receive instructions on how to perform the maintenance and the tools necessary. The maintainer 220 may be shown a video series on the handheld device 210a showing each of the steps of the required maintenance. A local handheld device (e.g. 210a) may detect whether or not the proper steps were performed. The observer 240 may be in a remote location, and may receive information about the maintainer 220, or the user 230, information on progress updates, and visual data (pictures and/or video) to oversee the tasks being performed.

The communication paths for the outgoing database information 212a-c and the incoming database information 213a-c are preferably wireless, such as WiFi or 3G or 4G wireless network protocols.

The mobile wireless handheld devices 210a-c can communicate directly to each other as enabled by the database 250, or may communicate using the database 250 as a teleconferencing server.

In some embodiments, the observer 240 observes using conventional computer or video conferencing equipment, rather than using a handheld device 210c.

### Exemplary Operation

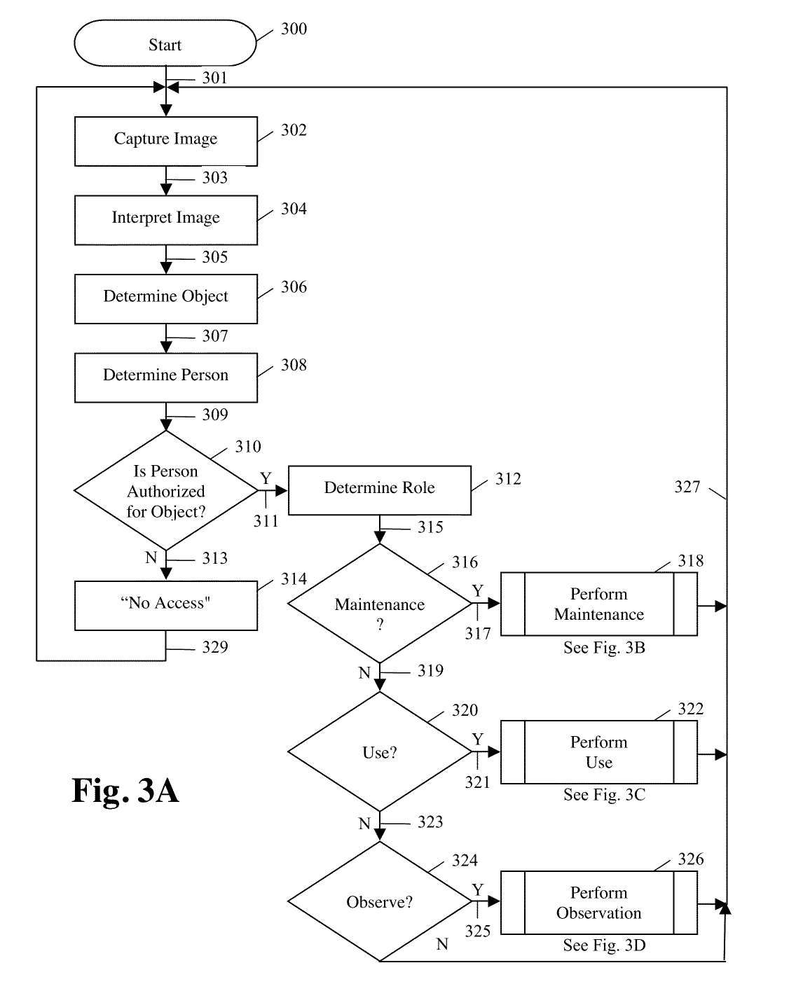

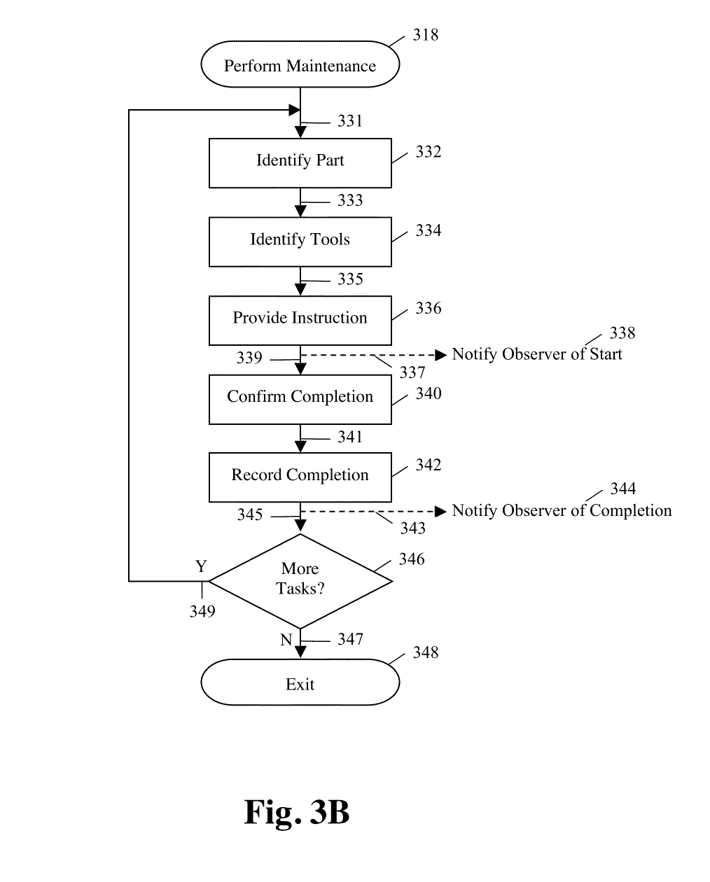

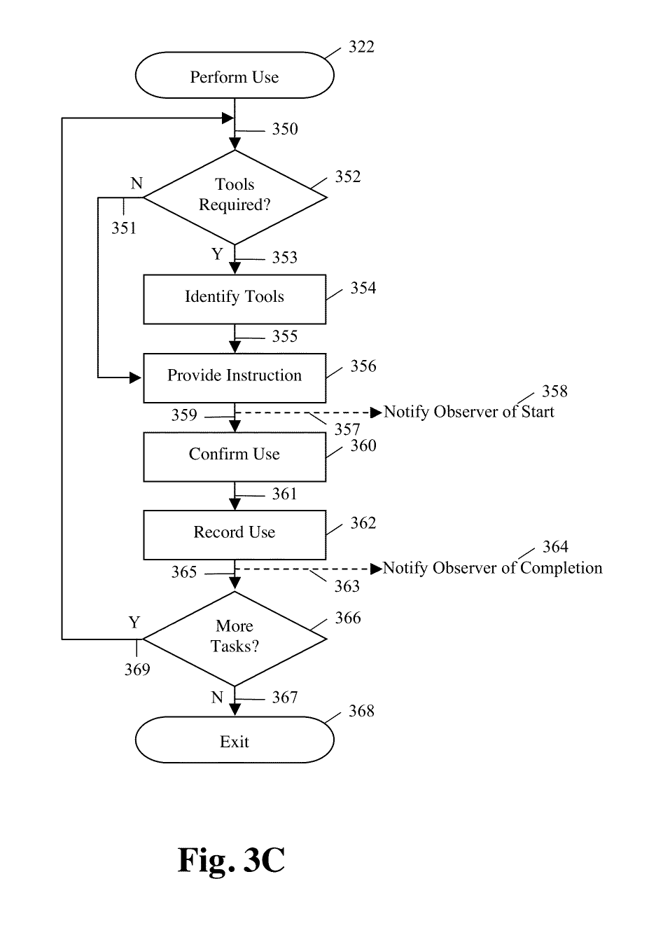

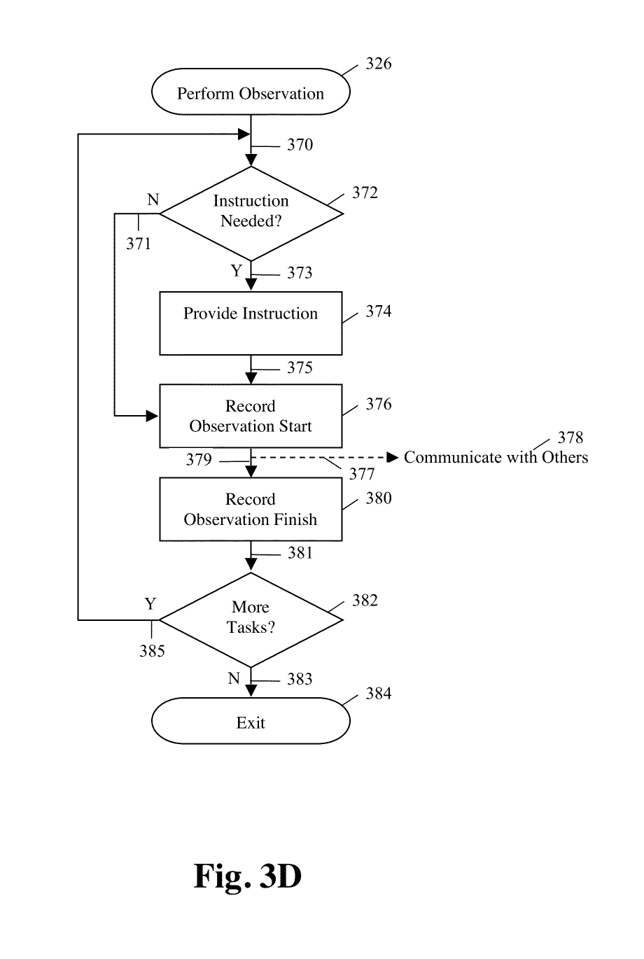

FIG. 3A through FIG. 3D provide flowcharts for method aspects of an embodiment of the invention. Other embodiments may omit or add steps, or perform steps in different orders.

FIG. 3A is a top-level flowchart. The process starts at step 300 and moves along path 301 to a capture image step 302 where the image is captured by a handheld device 210. The process moves along path 303 to an interpret image step 304 where the image is interpreted. The image may be interpreted by the handheld device 210 or by the database 250. Then the process moves along path 305 to a determine object step 306 where the medical object is determined from data stored in the database based on the image data 211. Then the process moves along path 307 to a determine person step 308. The medical practitioner/technician may be determined based on a device code unique to the handheld device (e.g. 210a or 210b), by the scan label (e.g. 120a or 120b), or by a face, fingerprint, or iris scan. This checks the identity of the individual running the handheld device 210. The process then moves along path 309 to a decision 310 where it checks if the person is authorized for medical object. If not, the process moves along path 313 to “No Access” step 314 where it will send a message stating “No Access” and moves along path 329 back to path 301. If yes, the process moves along path 311 to a determine role step 312 where the role will be determined for the person determined in step 308. Then the process decides which sub-process to perform based on the role: maintenance, use, or observation. First the process moves along path 315 to maintenance? decision 316 to decide if the role is maintenance. If yes, the process moves along path 317 to perform maintenance step 318 (see FIG. 3B) and then moves along path 327 back to path 301. If not, the process moves along path 319 to use? decision 320 to decide if the role is use. If yes, the process moves along path 321 to perform use step 322 (see FIG. 3C) and then moves along path 327 back to path 301. If not, the process moves along path 323 to observe? decision 324 to decide if the role is observe. If not the process moves along path 327 back to path 301. If yes, the process moves along path 325 to perform observation step 326 (see FIG. 3D) and then moves along path 327 back to path 301.

In some embodiments, the perform observation step 326 is triggered independently, for example, by the notify observer of the start of maintenance message 338 in FIG. 3B or by the notify observer of the start of use message 358 in FIG. 3C. In those embodiments, the observer 240 does not need to scan the medical object's label, but instead may be optionally identified by their handheld device 210c or by scanning their ID scan label 120c, and associated with the observer role by data stored in the database. In other embodiments the observer 240 is identified by the conventional computer or video conferencing equipment they are using or by their physical location.

FIG. 3B is a flowchart for the perform maintenance 318 process. The process begins along path 331 to an identify part step 332 where a maintenance part is determined. Next the process moves along path 333 to an identify tools step 334, where the tools associated with the current maintenance part are identified. The process moves along path 335 to a provide instruction step 336. Instructional information regarding the current maintenance part, use of tools, how the maintenance is performed is provided, for example, as incoming database information 213a from the database 250 to the handheld device 210a. The instructional information could include videos of the maintenance process. At event 337, a notify observer of the start of maintenance message 338 is sent. The handheld device 210c associated with the observer 240 is notified along communications path 213c. The observer can observe the maintenance procedure via pictures, audio, and/or video transmitted to the handheld device 210c (or in some embodiments, to conventional computing or video conferencing equipment). The information in message 338 is sufficient to automatically authorize and enable the observer 240 to observe the maintenance without requiring further actions by the observer 240. The observer 240 can watch what is happening and will subsequently wait for confirmation of the maintenance completion. When the maintenance is completed, the process moves along path 339 to the confirm completion step 340, the handheld device 210a will send completion information back to the database 250. The process will then move along path 341 to a record completion step 342 where the completion of the task is recorded in the database 250. The database 250 can log the time and date of the maintenance as well as logging the medical practitioner/technician who performed the maintenance, the tools used, how long it took, and so forth. At event 343, a notify observer of the completion of maintenance message 344 is sent. The observer 240 could verify that the maintenance was performed as required and can then turn attention to other matters. The optional verification could include sending a verification message to the database 250. Then the process moves along path 345 to more tasks? decision 346 to determine if there are more maintenance tasks. If so, the process moves along path 349 to path 331 to repeat the cycle. If not, the process moves along path 347 to exit 348.

FIG. 3C is a flowchart for the perform use 322 process. The process begins along path 350 to a tools required? decision 352. If so, the process moves along path 353 to an identify tools step 354 where tools are identified and continues along path 355. If not, the process moves along path 351 and skips step 354. At a provide instruction step 356, information regarding use, and tools if applicable, is provided to the handheld device 210b of the user 230. The instruction could include a checklist, pictures, audio, and/or video. At event 357, a notify observer of the start of use message 358 is sent. The handheld device 210c associated with the observer 240 is notified along communications path 213c. The observer 240 can observe the use via pictures, audio, and/or video transmitted to the handheld device 210c (or in some embodiments, to conventional computing or video conferencing equipment). The observer 240 may wait for notice of use completion. When use is completed, the process moves along path 359 to the confirm use step 360, the handheld device 210b will send use information back to the database 250. The process will then move along path 361 to a record use step 362. The database 250 can log the time and date of the use as well as logging the medical practitioner/technician who performed the use, the tools used, how long the medical object was used, and so forth. At event 363, a notify the observer of the completion of use message 364 is sent. Then the process moves along path 365 to more tasks? decision 366 to determine if there are more use tasks. If so, the process moves along path 369 to path 350 to repeat the cycle. If not, the process moves along path 367 to exit 368.

FIG. 3D is a flowchart for the perform observation 326 process. The process begins along path 370 to an instruction needed? decision 372. If so, the process moves along path 373 to a provide instruction step 374, where instruction regarding the observation is provided, and continues along path 375. If not, the process moves along path 371 and skips step 374. At the provide instruction step 374, information is provided to the handheld device 210c of the observer 240. The instruction could include a checklist, pictures, audio, and/or video. In record observation start step 376, it is noted that the observer 240 has started the observation. During the observations, at event 377, the observer 240 may communication with others, e.g. the maintainer 220 or the user 230. The communication with others 378 could be instructional, corrective or supportive information. The handheld device 210c associated with the observer 240 will send communication 378 to other handheld devices (e.g. 210a or 210b). When the observer 240 stops observing, the process moves along path 379 to the record observation finish step 380, the handheld device 210c will send observation information back to the database 250. The database 250 can log the time and date of the observation as well as logging the person who observed, how long the observation took, the types of communication that occurred during the observation, and so forth. Then the process moves along path 381 to more tasks? decision 382 to determine if there are more observation tasks. If so, the process moves along path 385 to path 370 to repeat the cycle. If not, the process moves along path 383 to exit 384.

### Database

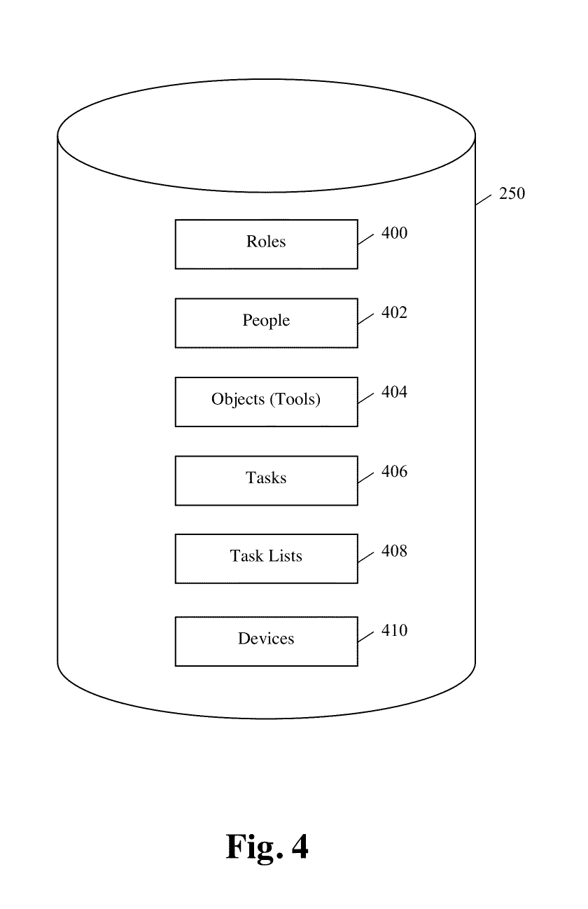

FIG. 4 illustrates the types of information that the database 250 will hold and maintain. The database 250 can be any data repository including relational, hierarchical, etc. The data schema will support various entities including roles 400, people 402, objects (including medical objects 200 and tools and supplies 510) 404, tasks 406, task lists 408, and devices 410. The storage of this information on a single, centrally accessible database is valuable to proper communication and coordination.

The data regarding roles 400 include the roles of various people associated with various medical objects. For example, an individual may be a maintainer of a particular object, such as a machine, but may be a user of another object, such as a tool used to fix the machine. The individual may also be a supervisor for another maintainer and will be notified as an observer whenever the maintainer they supervise is performing maintenance. Thus the same individual may have the role of maintainer, user, and observer. These relationships are tracked in the roles 400, people 402, and objects (tools) 404 data tables.

Means for identifying people such as ID badges, fingerprints, face scans, or iris scans are stored in the people 402 data table. Relationships of people 402 to roles 400, objects 404, task lists 408, and devices 410 are also tracked in the database.

Medical object specific tasks 406 and instructions associated with those tasks are stored in the tasks 406 portion of the database. Medical object specific instructions may include documents, checklists, pictures, audio, and/or video.

### Exemplary Use

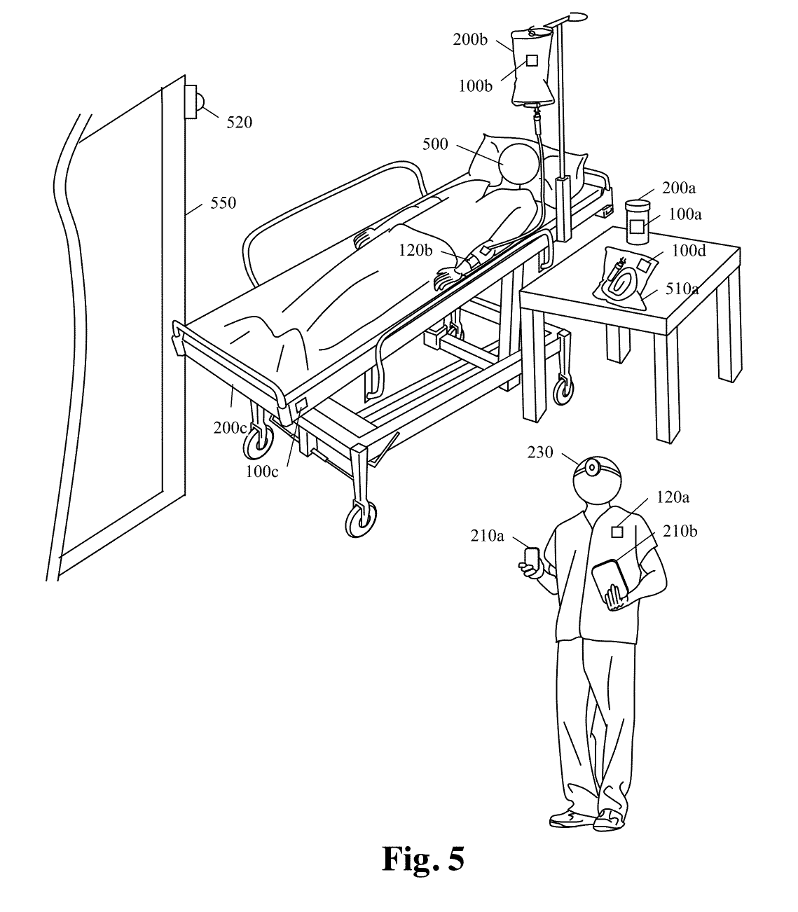

FIG. 5 shows how a user 230, such as a medical practitioner or medical technician, can use a handheld device 210 and various communication methods. The user 230 identified by the scan label 120 can access information from the handheld device 210. The handheld device 210 could be pocket sized such as an Apple iPhone, Android phone or other smart phone 210a or a tablet such as an Apple iPad, Amazon Kindle or other handheld tablet 210b. A remote observer 240, such as an ordering physician, a monitor technician, or a nurse manager, can observe using various cameras, such as mounted camera 520 shown on a mounting structure 550, shown as a wall. The handheld device 210 can identify patient 500 by reading scan label 120b to review health history to determine what tasks are to be performed regarding the patient 500, and to get more information regarding the patient 500. In some embodiments, the patient data may include a photograph, a fingerprint, or an iris scan to double check the patient's ID. The database 250 will determine if the practitioner 230 is authorized to work with the patient 500. If so, the user-specific workflow will be displayed, such as tasks, medications, and procedures. The system also determines whether the specific medical practitioner/technician is authorized to perform the task, such as a) give medication 200a b) start IV bag 200b, or c) repair or calibrate a device.

In the example of giving a medication, the handheld device 210 can identify the drug container 200a by reading coded label 100a and display the corresponding drug order to determine how the drug is to be administered and what is the proper dosing, to confirm that the right drug is being given to the right patient, and to check for drug interactions. The handheld device 210 matches the medication with the order and performs dosage calculations (e.g. weight or potassium (K+) level with cross check to most recent lab data). The database 250 can track exactly when the drug was given, to whom it was given, and who gave it.

In the example of starting an IV bag 200b, the handheld device 210 can identify the IV bag 200b by reading coded label 100b, display the drug order, determine what is the proper dosing, and confirm that the right drug is being given to the right patient. The database 250 can assimilate this information and determine whether the user 230 will need tools or materials, such as IV tubing 510a or a catheter, for this particular medical task. The database 250 can track exactly when the IV was started, to whom it was given, and who gave it. It can also track when the IV tubing 510a, or a catheter, was first used and thus when it needs to be replaced.

If a procedure is to be done, such as an IV or catheter, the handheld device 210 scans the medical device's code label, such as 100b for the IV bag 200b, 100c for the hospital bed 200c, or 100d for the IV tubing 510a. The handheld device 210 confirms the proper device, calibration, maintenance, etc. and provides an on-screen checklist and instructions, such as pictures, audio, and/or video.

At the same time, the system tracks that the specific practitioner 230 is interacting with the patient 500 or the drug 200a or IV bag 200b. The system can notify one or more observers 240 who are required to observe or who may be interested and authorized to observe. The system may automatically observe. For example, if a specific material or tool 510 (such as IV tubing 510a) is required, the system can notify the user 230, provide instructional information, including video information to the user 230 via the handheld device 210, and the monitor the use to ensure that it is performed properly. If the procedure is not performed properly, the system, or an observer 240, can correct the situation while the user 230 is with the patient 500 and performing the task. Further, if there is a problem, additional instruction may be provided via pictures, audio, and/or video. Details of the performance of the procedure, and optional observation, are stored in the database 250 as part of the overall medical history and record, and can be used to improve procedures, training, and safety.

In some embodiments, the mounted camera 520 can scan all of the coded labels 100 and scan labels 120 as well as recognize Medical objects 200, tools 510, and patients 500. Once a practitioner 230, a patient 500, and a medical object 200 are identified in proximity, the system could instruct the practitioner 230 via the handheld device 210 to perform the procedure. The system could observe the entire interaction and provide instruction prior to each task as well as providing corrective feedback and instruction when the wrong actions or medications or materials are observed. The system would also record information regarding the practitioner 230, the patient 500, the medical object 200, and the interactions. The recorded information can be stored in the database 250 and reviewed at a later time.

### Advantages

### Common Repository

The present invention can be used to provide a common repository for central storage of data and that can be shared among users throughout the organization and between organizations that are working together.

### Role Based

The present invention can be used to assign roles to individuals associated with various medical objects or tasks.

### Discipline Based

The present invention can be used to assign disciplines to individuals and provide instruction, tracking and control based on those disciplines.

### Specific Media Rich Instructions

The present invention can be used to provide instructions regarding specific medical objects to specific individuals in a variety of mediums including documents, checklists, pictures, audio, and/or video.

### Verification and Ratification

The present invention can be used to verify and ratify information for medical objects and individuals.

### Maintenance Notification and Instructions

The present invention can be used to provide maintenance notification and instructions regarding specific medical objects to specific individuals.

### Log Maintenance and Events

The present invention can be used to log maintenance and events for medical objects.

### Reporting

The present invention can be used to provide reports on given medical objects and individuals or a combination of the two.

### Presenting Information in a Variety of Mediums

The present invention can be used to provide information in a variety of mediums including documents, checklists, pictures, diagrams, audio and/or video.

### Problem Solving

The present invention can be used to provide the ability for problem solving via knowledge bases that can be associated with medical objects and individuals.

### Easy to Use

The present invention is easy to use.

### Quick

The present invention's unique design allow for quick use and time-saving when compared to conventional methods.

### Effective

The present invention is effective, allowing for multiple sources of identification and providing helpful information to streamline the work that needs to be done.

### Simplifies Medical Procedures

The present invention allows for the simplification of many medical procedures by providing correlated patient medical information to the practitioners as well as providing instruction for necessary procedures.

### Access Patient Information

The present invention allows for the access of patient information including their medical record and history. It brings up pertinent data associated with specific medicine or medical devices or materials.

### Quick Diagnosis and Treatment

With the patient data all in one place, the present invention will allow for quicker diagnoses and other medical decisions. The time saved due to the accessibility of the information will increase productivity and allow medical practitioners to see more clients and treat them more effectively.

### Accuracy of Treatment

With the patient data all in one place, the present invention will allow for more accurate treatment. It can be used to prevent the misapplication of medications or procedures.

### CONCLUSION, RAMIFICATION, AND SCOPE

Accordingly, the reader will see that the improved, universal, role and discipline based, low cost means and method of medical object identification, tracking and control are easy to use, quicker and accurate and can be used with medical objects or individuals to provide up-to-date pertinent information using methods such as on screen instructions, checklists, videos, pictures, diagrams, etc. or any combination thereof.

While the above descriptions contain several specifics these should not be construed as limitations on the scope of the invention, but rather as examples of some of the preferred embodiments thereof. Many other variations are possible. The variations could be used without departing from the scope and spirit of the novel features of the present invention.

Accordingly, the scope of the invention should be determined not by the illustrated embodiments, but by the appended claims and their legal equivalents.

We claim:

1. A system for use in a medical environment for medical object recognition and control, the system comprising:
a) a plurality of handheld devices configured to be used by a plurality of medical practitioners and medical technicians, and
b) a database configured to communicate with the plurality of handheld devices, wherein each handheld device comprises:
i) a camera configured to scan an image of a medical object,
ii) a display for displaying information, and
iii) a wireless network connection to the database for sending outgoing database information to the database and for receiving incoming database information from the database,
wherein the system is further configured to recognize the medical object by interpreting a coded label,
wherein the handheld device is further configured to identify a medical practitioner or technician using the handheld device, by scanning one of a face,
an iris, a fingerprint, or a scan label of the medical practitioner,
wherein the database is configured to store data relating to the medical object, the handheld devices, and the plurality of medical practitioners or medical technicians,
wherein the database data includes role information for the medical practitioner or technician based on the medical object, wherein the role is one of the group of maintenance, use, and observation,
wherein the database contains medical object specific instructions for each role, wherein the medical object specific instructions comprise one or more of the group of:
i) checklist,
ii) pictures,
iii) audio, and
iv) video;
whereby when a first one of the plurality of handheld devices scans the medical object, the system recognizes the medical object and determines the role of the medical practitioner or technician, the database sends the medical object specific instructions to the first handheld device, the medical object specific instructions are displayed on the first handheld device, and the database records data about the medical object recognized, the first handheld device, and the medical practitioner.

2. The system of claim 1, wherein the role of the medical practitioner or medical technician is maintenance,
wherein the medical object specific instructions include a list of parts and tools required, if any, and at least one video showing the maintenance steps.

3. The system of claim 1, wherein the role of the medical practitioner is use,
wherein the medical object specific instructions include at least one video showing how to perform a task using the medical object.

4. The system of claim 1, wherein the role of the medical practitioner is observer,
wherein the observer is notified of the start of maintenance or use of the medical object by another medical practitioner.

5. A system for use in a medical environment for medical object recognition and control, the system comprising:
a) a plurality of handheld devices configured to be used by a plurality of medical practitioners, and
b) a database configured to communicate with the plurality of handheld devices, wherein each handheld device comprises:
i) a camera configured to scan an image of a medical object,
ii) a display for displaying information, and
iii) a wireless network connection to the database for sending outgoing database information to the database and for receiving incoming database information from the database,
wherein the database is configured to store data relating to the medical object, the handheld devices, and the plurality of medical practitioners,
whereby when a first one of the plurality of handheld devices scans the medical object, the system recognizes the medical object, the database sends medical object specific instructions to the first handheld device, the medical object specific instructions are displayed on the first handheld device, and the database records data about the medical object recognized and the first handheld device.

6. The system of claim 5 wherein the system is further configured to recognize the medical object by interpreting a coded label.

7. The system of claim 5 wherein the handheld device is further configured to identify a medical practitioner using the handheld device.

8. The system of claim 7 wherein the medical practitioner is identified by scanning a scan label associated with the medical practitioner.

9. The system of claim 7 wherein the medical practitioner is identified by scanning one of a face, an iris, or a fingerprint.

10. The system of claim 7 wherein the database is configured to maintain role information for the medical practitioner based on the medical object, wherein the role is one of the group of maintenance, use, and observation.

11. The system of claim 10 wherein the medical object specific instructions are based on the role of the medical practitioner.

12. The system of claim 10 wherein the medical object specific instructions comprise one or more of the group of:
i) checklist,
ii) pictures,
iii) audio, and
iv) video.

13. The system of claim 7 wherein the database is configured to maintain role information for the medical practitioner based on the medical object,
wherein the role of the medical practitioner is maintenance,
wherein the medical object specific instructions include a list of parts and tools required, if any, and at least one video showing the maintenance steps.

14. The system of claim 7 wherein the database is configured to maintain role information for the medical practitioner based on the medical object,
wherein the role of the medical practitioner is use,
wherein the medical object specific instructions include at least one video showing how to perform a task using the medical object.

15. The system of claim 7 wherein the database is configured to maintain role information for the medical practitioner based on the medical object,
wherein the role of the medical practitioner is observer,
wherein the observer is notified of the start of maintenance or use of the medical object by another medical practitioner.

16. A handheld device for use in a medical environment for medical object recognition and control to be operated by a medical practitioner having a predetermined role, the handheld device comprising:
a) a camera configured to scan an image of a medical object,
b) a display for displaying information, and
c) a wireless network connection, configured to communicate to a database, for sending outgoing database information to the database and for receiving incoming database information from the database,
wherein the handheld device interacts with the database to recognize the medical object,
wherein the handheld device identifies the medical practitioner using the handheld device,
wherein the predetermined role is one of the group of maintenance, use, and observation,
wherein the handheld device sends and receives data relating to the medical object, the handheld device, and the medical practitioner,
wherein the data received contains medical object specific instructions for the predetermined role,
wherein the medical object specific instructions comprise one or more of the group of:
i) checklist,
ii) pictures,
iii) audio, and
iv) video;
whereby the medical object specific instructions are displayed on the display.

17. A method for use in a medical environment for medical object recognition and control using the handheld device of claim 16, the method comprising the steps of:
a) capturing an image with the camera,
b) interpreting the image,
c) determining a medical object,
d) determining an identity of the medical practitioner,
e) determining if the medical practitioner is authorized for the medical object,
f) if not authorized, indicating no authorized access,
g) otherwise, based on the predetermined role of the medical practitioner allowing and tracking one or more of the group of:
i) performing maintenance,
ii) performing use, and
iii) performing observation.

18. The method for medical object recognition and control of claim 17 further comprising steps for performing maintenance of the medical object:
a) identifying a part associated with the maintenance of the medical object,
b) identifying zero or more tools that may be required for the current part,
c) displaying medical object specific instructions for the current maintenance task,
d) confirming completion of the current maintenance task associated with the part,
e) sending completion information to the database for recording in the database,
f) if more tasks are required, performing steps a) through e) for each remaining maintenance task.

19. The method for medical object recognition and control of claim 17 further comprising steps for performing use of the medical object:
a) if tools are required for the use of the medical object, identifying one or more tools,
b) providing medical object specific instructions for use of the medical object,
c) confirming completion of the current use task,
d) sending completion information to the database for recording in the database,
e) if more tasks are required, performing steps a) through d) for each remaining use task.

20. The method for medical object recognition and control of claim 17 further comprising steps for performing observation of the medical object:
a) if instruction is needed, providing medical object specific instructions,
b) sending observation start information to the database for recording in the database,
c) sending observation finish information to the database for recording in the database,
d) if more tasks are required, performing steps a) through c) for each remaining observation task.
